(19) United States
(12) Patent Application Publication
(10) Pub. No.: US 2012/0140600 A1
(43) Pub. Date: Jun. 7, 2012

(54) TABLE LAMP WITH ALARM CLOCK

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/288,029

(22) Filed: Nov. 3, 2011

(30) Foreign Application Priority Data
Dec. 6, 2010 (TW) 099142470

(51) Int. Cl. G04B 47/00

(52) U.S. Cl. 368/10

(57) ABSTRACT

A table lamp includes a lamp base, a clock, and a controlling module. The lamp base receives an LED module therein. The controlling module includes a timer electrically connected to the clock and a controller electrically connected to the LED module and a speaker. The timer is configured for setting an alarm time for the clock. When the clock goes to the alarm time set by the timer, the controller turns on LEDs of the LED module one by one within a desired time and turns on the speaker to generate arousal sound.

### BACKGROUND

1. Technical Field

The present disclosure relates to a table lamp, and particularly to a table lamp with an alarm clock for waking people up at the required moment.

2. Description of Related Art

A conventional table lamp has a single function of lighting and does not have a function of awaking people from sleep. A conventional alarm clock has a function of awaking people from sleep by generating a specific sound, for example, beep. However, for a deeply asleep person who is insensitive to sound, it is not easy to wake him up by such an alarm clock. The alarm clock may fail to wake the deeply asleep person up just by the sound generated thereby.

It is thus desirable to provide a table lamp which can overcome the limitations described.

### BRIEF DESCRIPTION OF THE DRAWINGS

FIG. 1 is a perspective view of a table lamp in accordance with an exemplary embodiment of the present disclosure.

FIG. 2 is a schematic bottom view of a casing of the table lamp of FIG. 1, wherein an LED module is attached to a bottom of the casing.

FIG. 3 is a block diagram of a controlling circuit of the table lamp of FIG. 1.

### DETAILED DESCRIPTION

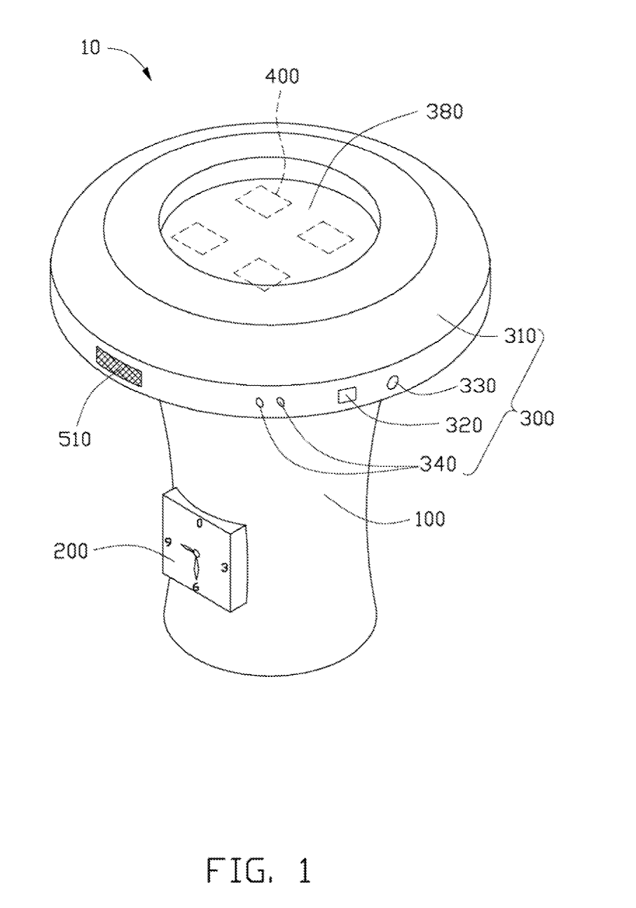

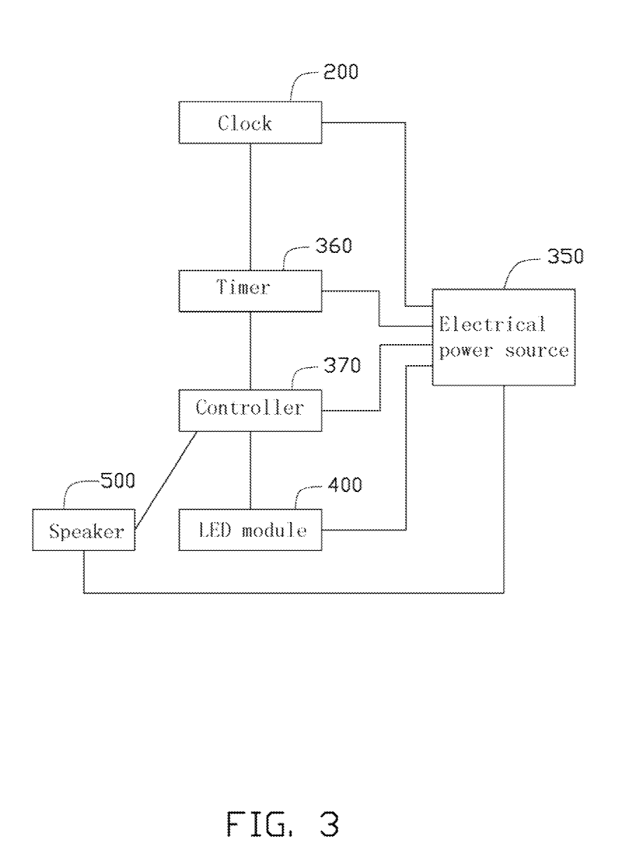

Referring to FIG. 1, a table lamp 10 according to an exemplary embodiment of the present disclosure includes a lamp base 100, a clock 200, an LED module 400, a speaker 500 (FIG. 3), and a controlling module 300.

The lamp base 100 is hollow and made of a light-permeable material, such as transparent or translucent plastic. The lamp base 100 is generally cylinder-shaped. The clock 200 for showing time is attached to an outer side face of the lamp base 100. The LED module 400 is received in the lamp base 100, and light generated by the LED module 400 can transmit through the lamp base 100 for illumination. In this embodiment, the LED module 400 includes four LEDs (not labeled).

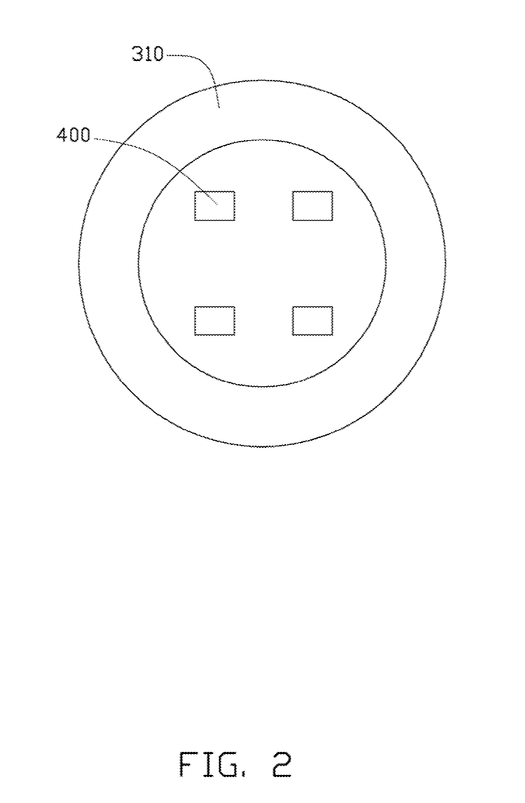

Also referring to FIGS. 2-3, the controlling module 300 is arranged on a top of the lamp base 100. The controlling module 300 includes a circular casing 310, an electrical power source 350, a timer 360 and a controller 370. The electrical power source 350, the timer 360, the controller 370, and the speaker 500 are received in the casing 310.

The casing 310 of the controlling module 300 is mounted on the top of the lamp base 100. The LED module 400 is attached to a central portion of a bottom face of the casing 310 which faces an interior of the lamp base 100. The casing 310 defines a circular cavity 380 in a top face thereof for receiving essential oil or incense (not shown) therein, which can give off aroma under heating of the LED module 400.

The electrical power source 350 is respectively connected to the clock 200, the timer 360, the controller 370, the LED module 400, and the speaker 500, thereby providing electrical power for these components. Alternatively, the table lamp can be designed to directly connect with an external electrical power supply to obtain electric power for the clock 200, the timer 360, the controller 370, the LED module 400, and the speaker 500, whereby the electrical power source 350, which in the preferred embodiment is a battery, can be omitted.

The timer 360 electrically connects the clock 200. The controller 370 electrically interconnects the timer 360 and the LED module 400 and the timer 360 and the speaker 500. Referring to FIG. 1 also, an electrical power source switch 320 is provided on the casing 310 for controlling the electrical power source 350 to turn on or turn off, a timing knob 330 is provided on the casing 310 for controlling the timer 360, and two mode selecting buttons 340 are provided on the casing 310 for controlling the controller 370. A speaker grille 510 is provided on the casing 310 corresponding to the speaker 500, whereby sounds generated by the speaker 500 can transmit out of the casing 310 to an outside. The electrical source switch 320 is for switching the table lamp 10 on and off. The timer 360 sets an alarm time for the clock 200 by manipulating the timing knob 330.

A user can choose different lighting modes of table lamp 10 by pressing the mode selecting buttons 340. When one of the mode selecting buttons 340 is pressed, all of the LEDs of the LED module 400 are lighted at the same time, thereby providing sufficient light intensity for illumination. When the timer 360 is manipulate to set an alarm time for the clock 200, the other mode selecting button 340 needs to be pressed. When the clock 200 goes to the alarm time set by the timer 360, the controller 370 turns on the LEDs of the LED modules 400 one by one within a desired time, and the speaker 500 simultaneously generates arousal sound, for example, beep, with a gradually increasing volume. Therefore, the table lamp provides both light and sound effects for waking people up.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A table lamp, comprising:
a lamp base;
a plurality of LEDs received in the lamp base for generating light;
a clock mounted on the lamp base; and
a controlling module mounted on the lamp base, the controlling module comprising:
a timer electrically connecting with the clock for setting an alarm time for the clock; and
a controller electrically interconnecting the timer and the LEDs for turning on the LEDs when the clock goes to the alarm time set by the timer.

2. The table lamp of claim 1, wherein the lamp base is substantially cylinder-shaped, and a casing is coupled to a top of the lamp base and receives the controlling module therein.

3. The table lamp of claim 2, wherein the casing defines a cavity in a top face thereof for receiving aroma-generating substance therein.

4. The table lamp of claim 2, wherein the LEDs are mounted on a bottom face of the casing and faces an interior of the lamp base.

5. The table lamp of claim 1, wherein the lamp base is light-permeable, and light generated from the LEDs transmits through the lamp base.

6. The table lamp of claim 1, wherein the clock is mounted on an outer face of the lamp base.

7. The table lamp of claim 2, further comprising an electrical power source for providing electrical power to the clock, the timer, the controller and the LEDs.

8. The table lamp of claim 7, further comprising an electrical source switch mounted on the casing and electrically connected to the electrical power source for switching the table lamp on and off.

9. The table lamp of claim 2, further comprising a timing knob mounted on the casing and electrically connected to the controlling module for setting the alarm time of the timer.

10. The table lamp of claim 2, further comprising two mode selecting buttons on the casing for selecting different lighting modes of the table lamp.

11. The table lamp of claim 10, wherein when one of the mode selecting buttons is pressed, all the LEDs are lighted at the same time, and wherein when the timer is used to set an alarm time for the clock, the other mode selecting button needs to be pressed.

12. The table lamp of claim 1, further comprising a speaker electrically connecting with the controller for generating sound when the clock goes to the alarm time set by the timer.

13. The table lamp of claim 12, wherein when the clock goes to the alarm time set by the timer, the speaker generates the sound with a gradually increasing volume, and the controller turns on the LED modules one by one within a desired time.

14. A table lamp, comprising:
a transparent lamp base;
an LED module received in the lamp base for generating light;
a speaker received in the lamp base for generating sound;
a clock fixed on an outer side of the lamp base; and
a controlling module comprising a timer and a controller, the timer electrically connecting with the clock for setting an alarm time for the clock, the controller electrically interconnecting the timer and the LED module and interconnecting the timer and the speaker, for turning on the LED module and the speaker when the clock goes to the alarm time set by the timer.
